(19) United States
(12) Patent Application Publication
(10) Pub. No.: US 2009/0268576 A1
(43) Pub. Date: Oct. 29, 2009

(54) METHOD OF HANDLING SERVO SECTOR DEFECT

(75) Inventor: Jin Wan Jun, Seoul (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/430,197

(22) Filed: Apr. 27, 2009

(30) Foreign Application Priority Data
Apr. 28, 2008 (KR) 1020080039255

(51) Int. Cl. G11B 20/18

(52) U.S. Cl. 369/53.41; G9B/20.046

(57) ABSTRACT

A method of handling a servo sector defect includes recognizing a first servo sector using a controller; determining whether the first servo sector has a defect; and when the first servo sector has a defect assigning at least a part of a next data sector to be assigned to the first servo sector to a second servo sector having no defect.

### PRIORITY CLAIM

A claim of priority is made to Korean Patent Application No. 10-2008-0039255, filed on Apr. 28, 2008, in the Korean Intellectual Property Office, the subject matter of which is hereby incorporated by reference.

### SUMMARY

Embodiments of the present invention relate to a hard disk drive (HDD), and more particularly to efficiently using data sectors of the HDD corresponding to a defective servo sector.

In a conventional HDD, a sector is generally defined to be 512 bytes. However, an HDD having increased capacity requires data to be recorded at a high density, and accordingly the size of a sector increases. For example, the sector size may increase from 512 bytes to 4,096 bytes.

As the sector size increases, efficiency deteriorates under conventional handling of defects. For example, when a defect is generated in servo sector, each data sector of the servo sector is entirely processed as if it were defective, so that data read/write operations may be impossible in that data sector.

According to an aspect of the present invention, there is provided a method of handling a servo sector defect. The method includes recognizing a first servo sector using a controller, determining whether the first servo sector has a defect, and when the first servo sector has a defect, assigning at least a part of a next data sector to be assigned to the first servo sector to a second servo sector having no defect.

Assigning at least a part of the next data sector to the second servo sector may include loading sector information corresponding to the first servo sector, using the controller, after the second servo sector is recognized.

Determining whether the first servo sector has a defect may include loading information stored in a defective servo information storage area, including information about at least one servo sector defect (SSD); and comparing the loaded SSD information with the first servo sector.

The SSD information may be sequentially stored by a servo sector index in the defective servo information storage area. The defective servo information storage area may include at least one of a maintenance area or a buffer. Loading the SSD information may include loading information about a servo sector corresponding to a first offset of the defective servo information storage area.

Loading sector information corresponding to the first servo sector after the second servo sector is recognized may include sequentially increasing the first offset until the second servo sector is recognized, and loading the sector information corresponding to a sector information offset when the second servo sector is recognized.

The method may further include increasing the sector information offset after the sector information corresponding to the sector information offset is loaded.

The sector information corresponding to the first servo sector may include at least one of information about a position of a first one of data sectors corresponding to the first servo sector, information about a data sector split by a servo sector next to the first servo sector, and information about the number of data sectors corresponding to the first servo sector.

### BRIEF DESCRIPTION OF THE DRAWINGS

Exemplary embodiments of the present invention will be described with reference to the attached drawings, in which:

FIG. 1 is a concept diagram showing data sectors, according to a conventional defect handling method;

FIG. 2 is a concept diagram showing data sectors having increased size, according to a conventional defect handling method;

FIG. 3 is a block diagram of an HDD, according to an exemplary embodiment of the present invention;

FIG. 4 is a concept diagram showing data sectors in a read/write operation of an HDD;

FIG. 5 is a flowchart showing a method of performing a read/write operation of a data sector in an SDD having no defective servo sectors;

FIG. 6 is a flowchart showing a method of handling a servo sector defect, according to an exemplary embodiment of the present invention; and

FIG. 7 is a concept diagram showing data sectors in a read/write operation of an HDD, according to an exemplary embodiment of the present invention.

### DETAILED DESCRIPTION OF THE EMBODIMENTS

The present inventive concept will now be described more fully with reference to the accompanying drawings, in which exemplary embodiments of the invention are shown. The invention, however, may be embodied in various different forms, and should not be construed as being limited only to the illustrated embodiments. Rather, these embodiments are provided as examples, to convey the concept of the invention to one skilled in the art. Accordingly, known processes, elements, and techniques are not described with respect to some of the embodiments of the present invention. Throughout the drawings and written description, like reference numerals will be used to refer to like or similar elements.

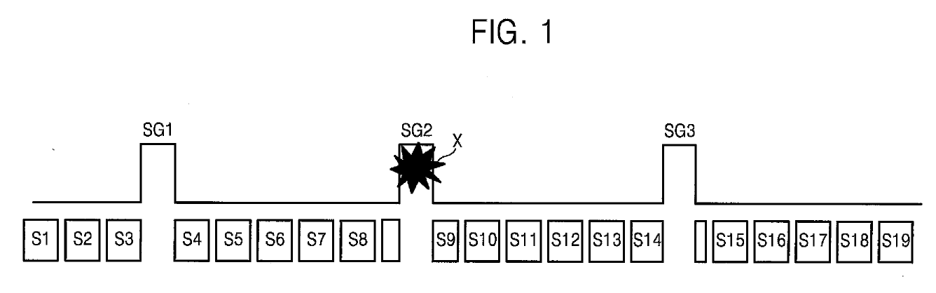

FIG. 1 is a concept diagram showing data sectors, according to a conventional defect handling method. Referring to FIG. 1, first, second and third servo gates SG1, SG2 and SG3 correspond to first, second and third servo sectors, respectively. When a defect is generated in the second servo sector (indicated by “X”), for example, data sectors S9 to S14 of the second servo sector are processed as being defective. Also, since data sector S14 is a split data sector (i.e., split between the second and third servo sectors), the part of data sector S14 in the third servo sector is also processed as being defective, and therefore not used. That is, only data sectors 515 to S19 of the third servo sector may be used.

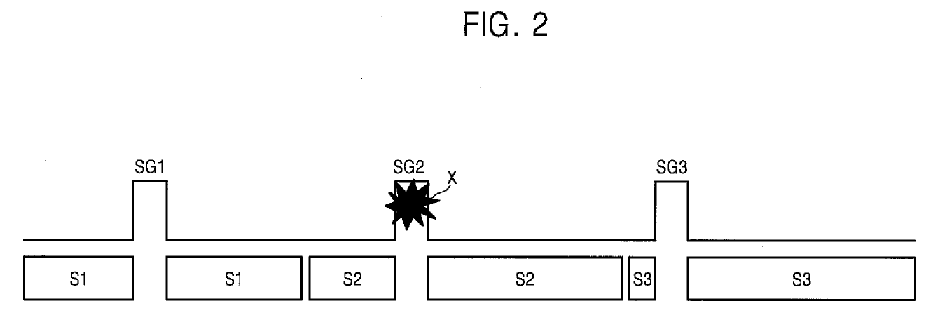

FIG. 2 is a concept diagram showing data sectors, according to a conventional defect handling method, in which the size of each data sector is increased as compared to the data sectors of FIG. 1. Referring to FIG. 2, when a defect is generated in the second servo sector (indicated by “X”), data sectors S2 and S3 of the second servo sector are processed as being defective. That is, the areas of the data sectors S2 and S3 are non-use areas where data read/write operations are not performed. Also, since data sector S3 is a split data sector, the part of the data sector S3 in the third servo sector is likewise processed as being defective. However, as compared to the split data sector S14 of FIG. 1, a larger area of the third servo sector is not used due to the increased size of the data sectors (e.g., split data sector S3).

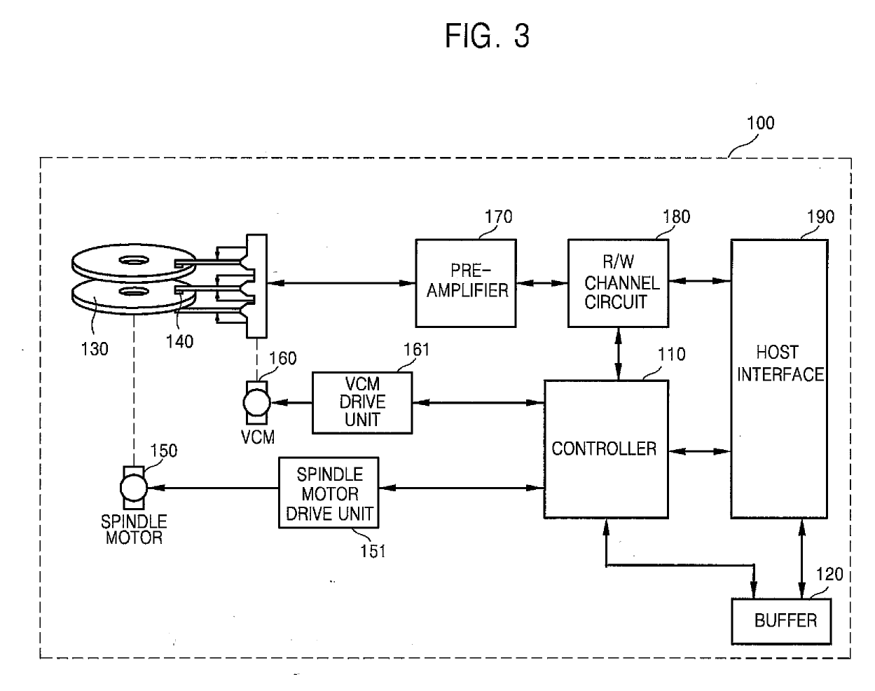

FIG. 3 is a block diagram of an HDD, according to an exemplary embodiment of the present invention. Referring to FIG. 3, HDD 100 includes a controller 110, a buffer 120, at least one disk 130, and a head 140. The HDD 100 may farther include a spindle motor 150, a spindle motor drive unit 151, a voice coil motor (VCM) 160, a VCM drive unit 161, an actuator (not shown), a pre-amplifier 170, a read/write (R/W) channel circuit 180, a host interface 190, and a memory (not shown).

The controller 110 is configured to perform a variety of control functions needed for driving the HDD 100. For example, in order to perform a data write operation to the at least one disk 130, the controller 110 outputs data to be written to the head 140 via the RAV channel circuit 180 and the pre-amplifier 170, and controls the location where the data is to be written on the at least one disk 130 by controlling the VCM 160 through the VCM drive unit 161 and the spindle motor 150 through the spindle motor drive unit 151.

The controller 110 may use predetermined firmware, for example, to perform various operations of the HDD 100, including the defect handling process, according to exemplary embodiments of the invention, described herein. The firmware may be stored in a predetermined memory, for example, such as random access memory (RAM) or NOR type flash memory (not shown), connected to the controller 110. It is understood that the controller 110 may be configured as any combination of hardware, software and/or firmware, without departing from the scope of the disclosure.

The buffer 120 may store data input from a host (not shown) through the host interface 190. Also, sector information, described below, may be stored in the buffer 120.

Each of the at least one disk 130 includes multiple tracks, as well as a maintenance area included in a maintenance cylinder. Information regarding the at least one disk 130 may be stored in the maintenance area. Each track includes at least one servo sector and data sectors. Information regarding the position of the head 140 and information regarding each track are stored in the servo sector.

When a defect exists or is generated in the servo sector, the position of the head 140 is not identified and the read/write operation is not performed with respect to the corresponding data sector(s). Additional information is therefore needed to perform the read/write operation with respect to the data sector(s).

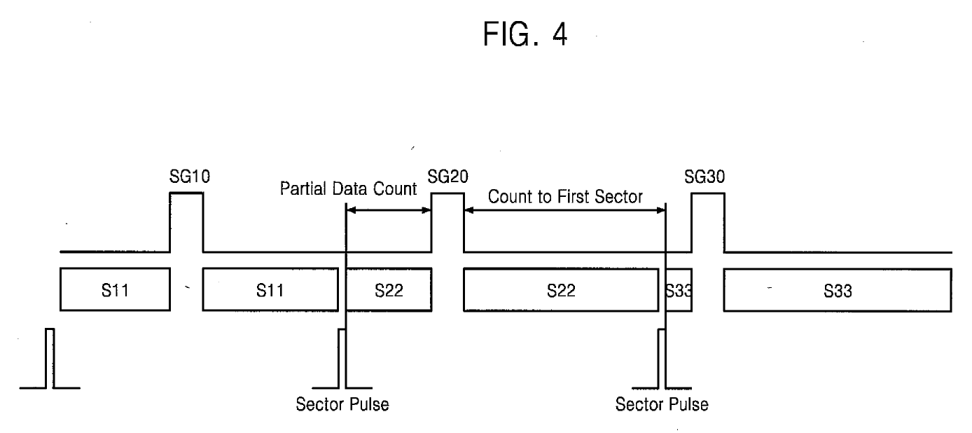

FIG. 4 is a concept diagram showing normal performance of a read/write operation with respect to a data sector in an HDD. Referring to FIGS. 3 and 4, the head 140 is positioned to be on-track at any one of the tracks of the at least one disk 130, under control of the controller 110. The head 140 transmits information stored on the track to the controller 110 via the pre-amplifier 170 and the R/W channel circuit 180. When the head 140 is positioned at any one servo sector of the track, information recorded in the servo sector may be transmitted to the controller 110. In the depicted example, a rising edge of a signal corresponding to each servo gate SG (e.g., servo gates SG10, SG20 and SG30) indicates the beginning of each servo sector. Also, the controller 110 receives the information recorded in the servo sector and outputs a servo interrupt signal (not shown).

As shown in FIG. 4, data sector S22 is split between adjacent first and second servo sectors, corresponding to servo gates SG10 and SG20, respectively. To read/write data with respect to the data sector S22, sector information corresponding to the second servo sector is automatically loaded in the controller 110 at the rising edge of the servo gate SG20 corresponding to the second servo sector. The sector information corresponding to the second servo sector may include information regarding data sectors of the second servo sector.

For example, in FIG. 4, the data sectors corresponding to the second servo sector include data sector S22, existing between the first servo sector and the second servo sector, and data sector S33, existing between the second servo sector and the third servo sector next to the second servo sector. Therefore, the sector information corresponding to the second servo sector includes information about data sectors S22 and S33. For example, the sector information for the second servo sector may include at least one of information regarding the position of the first data sector that begins in the second servo sector (e.g., data sector S33), referred to as count to first sector (CFS), information regarding the data sector split with the next consecutive servo sector (e.g., data sector S33 split with the third servo sector), referred to as partial data count (PDC), and information regarding the number of data sectors corresponding to the second servo sector (e.g., data sectors S22 and S33).

In an embodiment, the CFS signifies the first data sector other than a data sector split with a preceding servo sector, such as data sector S22 split between the first and second servo sectors. The CFS may also signify information as to when the first sector pulse (e.g., sector pulse corresponding to the second servo sector) is output by the controller 110 after the present servo sector.

Also, in an embodiment, the sector information includes PDC information. In FIG. 4, for example, the sector information corresponding to the second servo sector may include information about the PDC of data sector S33. The PDC information of data sector S22 may be included in the sector information corresponding to the preceding servo sector, i.e., the first servo sector corresponding to the servo gate SG10.

Also, in an embodiment, the sector information includes the number of data sectors corresponding to the servo sector. In FIG. 4, the number of the data sectors corresponding to the second servo sector, for example, is two (data sectors S22 and S33). Thus, for the head 140 to access the split portion of the data sector S22, for example, after passing the second servo sector, the sector information corresponding to the second servo sector needs to be loaded in the controller 110. The sector information may be stored in the buffer 120.

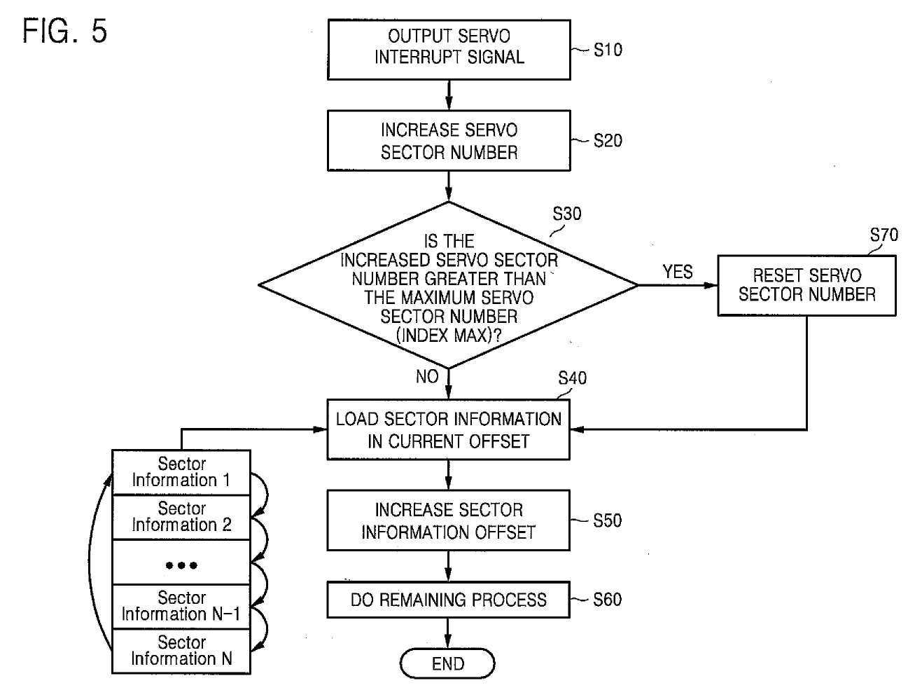

FIG. 5 is a flowchart showing a normal read/write operation of a data sector in an HDD, assuming no defective servo sectors. Referring to FIG. 5, the controller 110 recognizes a servo sector. When information received from the head 140 includes information stored in the recognized servo sector, the controller 110 outputs a servo interrupt signal, knowing that the head 140 is presently positioned on the recognized servo sector. That is, when the controller 110 recognizes a servo sector, the servo sector outputs a servo interrupt signal (S10) and increases a servo sector number (S20). For example, referring to FIG. 4, when the second servo sector is recognized, the servo sector number increases from one, corresponding to the first servo sector, to two, corresponding to the second servo sector.

The increased servo sector number is compared to a maximum servo sector number (index max) (S30). When the increased servo sector number is greater tan the maximum servo sector number, the servo sector number is reset (S70). For example, when there are eight servo sectors in a track, the servo sector number may be any of 0-7. Thus, when the increased servo sector number is 8, the servo sector number is reset to 0. In an embodiment, the increasing and/or resetting of the servo sector number may be performed by firmware driven by the controller 110.

When the increased servo sector number is not greater than the maximum servo sector number, sector information corresponding to the recognized servo sector (e.g., the second servo sector) is loaded (S40). The sector information corresponding to the recognized servo sector may be pointed to by current sector information offset. As described above, a data sector corresponding to the recognized servo sector may be accessed only when the sector information corresponding to the recognized servo sector is loaded in the controller 110. The sector information may be stored in advance, for example.

The sector information offset is automatically increased (S50). Thus, sector information corresponding to the next servo sector (e.g., the third servo sector) is pointed to. After the sector information is loaded in the controller 110 and the sector information offset is automatically increased, the HDD 100 performs remaining processes of a desired operation, such as a read/write operation with respect to the data sector(s) of the recognized servo sector (S60).

In a conventional defect handling method, when a defect is in a servo sector, the position of the head and the position of the end of the defective servo sector are not identified, and timing control is not performed. Also, the areas of the corresponding data sectors are not used. For example, referring to FIG. 4 for purposes of explanation, even when the sector information corresponding to the defective second servo sector is loaded in the controller 110, the area of the data sectors S22 and S33 would not be used in a conventional defect handling method. Further, sector pulses corresponding to data sectors S22 and S33 would be skipped, so that a sector pulse corresponding to a subsequent data sector (e.g., data sector S44, not shown in FIG. 4) would be generated. That is, if a conventional defect handling method were performed, the overall area corresponding to data sectors S22 and S33 would be unusable.

In comparison, according to embodiments of the present invention, when a servo sector having a defect is recognized, the sector information corresponding to the servo sector having the defect is not directly loaded. Rather, the sector information corresponding to the servo sector having the defect is loaded when a subsequent servo sector not having a defect is recognized, as discussed below. As a result, the use of disk space is more efficient.

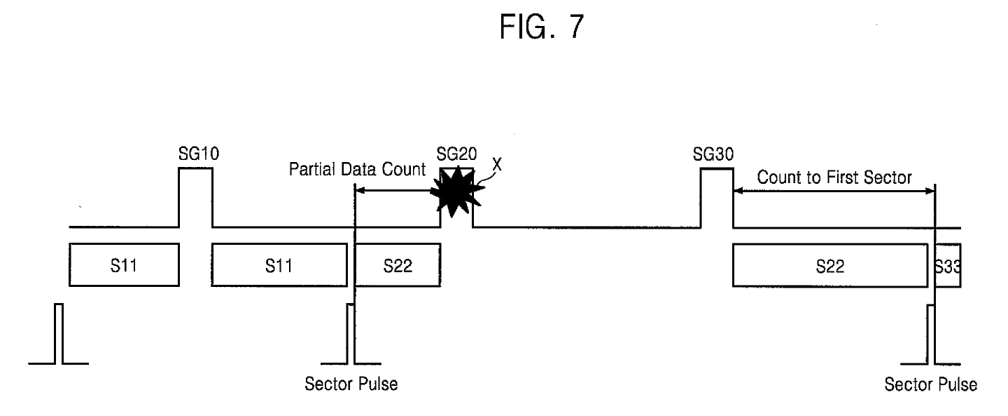

FIG. 7 is a concept diagram showing a method of performing a read/write operation with respect to a data sector in a defective servo sector of an HDD, according to an exemplary embodiment of the present invention. Referring to FIG. 7, the second servo sector, corresponding to the second servo gate SG20, includes a defect (indicated by “X”). Data sector S22 of the defective second servo sector is therefore assigned to the next servo sector having no defect, which is the third servo sector, corresponding to the third servo gate SG30. In the depicted embodiment, assigning a data sector in any of the tracks included in the at least one disk 130 signifies that the data sector becomes an area that is actually accessed by the controller 110 to perform a read/write operation.

Referring again to FIG. 4, if a conventional error handling method were used during the read/write operation, the track area corresponding to the combined areas of data sectors S22 and S33 would be unusable in the track. In contrast, according to the servo sector defect handling method shown in FIG. 7, only the track area corresponding to the area of the second servo sector itself (i.e., the area between the second and third servo gates SG20 and SG30) is unusable, which is less track area than the combined areas of data sectors S22 and S33. Thus, efficiency in use of disk space is improved.

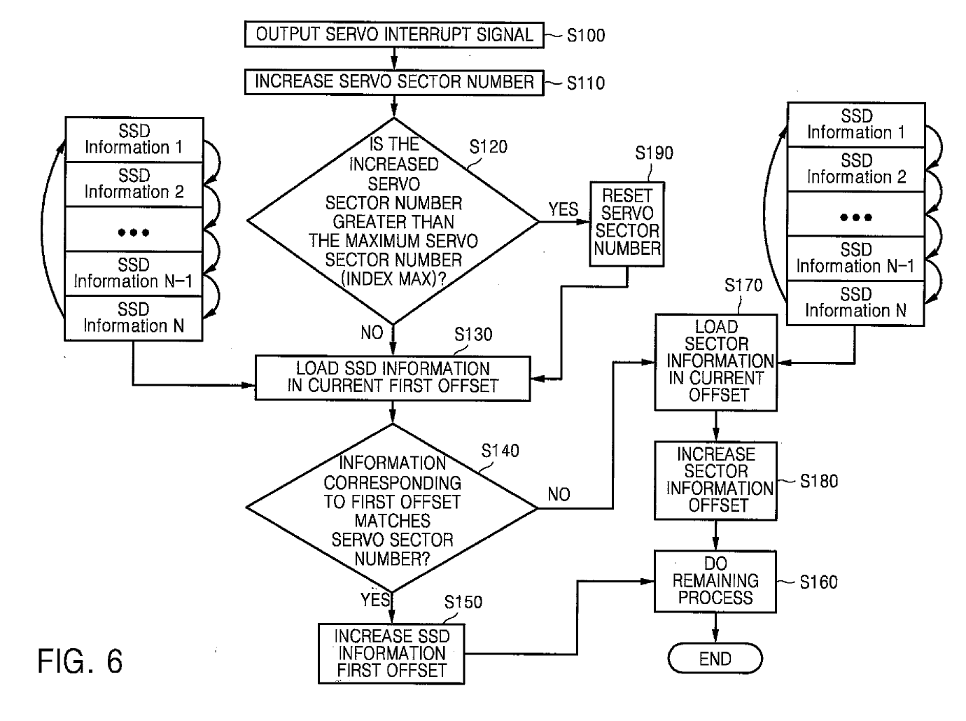

FIG. 6 is a flowchart showing a method of handling a servo sector defect, according to an exemplary embodiment of the present invention. Referring to FIGS. 6 and 7, the controller 10 recognizes a servo sector (e.g., the second servo sector), and outputs a servo interrupt signal (S100). The servo sector number increases in response to the servo interrupt signal (S110), indicating the servo sector (e.g., the second servo sector).

As discussed above, the increased servo sector number is compared to the maximum servo sector number (index max) (S120). When the increased servo sector number is greater than the maximum servo sector number, the servo sector number is reset (S190). In an embodiment, the increasing and/or resetting of the servo sector number may be performed by firmware driven by the controller 110, for example.

When the increased servo sector number is not greater than the maximum servo sector number (or after the increased servo sector number has been reset), the controller 110 determines whether the current servo sector (e.g., the second servo sector) has a defect. To accomplish this, the controller 110 loads information stored in a defective servo information storage area, which includes information about at least one servo sector defect (SSD) (S130). The loaded SSD information may be pointed to by a predetermined first offset.

The defective servo information storage area may be included in at least one of the maintenance area and the buffer 120, discussed above. For example, information about sectors having defects may be stored in the maintenance area in a processing step. Of the information about sectors having defects stored in the maintenance area, the information about a defective servo sector may be used as a defective servo information storage area. Also, in an embodiment, the SSD information may be stored in the buffer 120. The SSD information may be sequentially stored by a servo sector index (number), for example. Thus, as the first offset increases incrementally, the controller 110 may easily recognize information about the next defective servo sector.

For example, assuming second and fourth (not shown) servo sectors are defective, the current first offset of the SSD information indicates information corresponding to the second servo sector in the defective servo information storage area and the next first offset of the SSD information indicates information corresponding to the fourth servo sector. Then, the controller 110 compares information corresponding to the current first offset (e.g., information regarding the second servo sector) and the servo sector number to determine whether the second servo sector has a defect (S140). When the information corresponding to the first offset and the servo sector number match, the servo sector is determined to have a defect and the controller 110 does not yet load the sector information corresponding to the defective servo sector (e.g., the second servo sector). Rather, the first offset of the SSD information is increased (S150). For example, if the current first offset indicates SSD information corresponding to the second servo sector in the defective servo information storage area, the increased first offset (S150) indicates the next SSD information, which corresponds to the fourth servo sector, in the present example. Then, the controller 110 may perform remaining processes (S160). Since a data sector has not yet been assigned, the remaining processes may include processes other than the data read/write operation, for example.

When the servo sector is determined to have a defect, the controller 110 assigns at least a part of a data sector to be assigned next to the defective servo sector (e.g., data sector S22, which was to be assigned to the second servo sector) to the next defect-free servo sector (e.g., the third servo sector). For example, as shown in FIG. 7, a rear part of the split data sector S22 is assigned to the third servo sector. To this end, the controller 110 may sequentially increase the first offset until the defect-free servo sector (e.g., the third servo sector) is recognized, as discussed below.

More particularly, referring again to FIG. 6, the controller 110 recognizes the next servo sector (e.g., the third servo sector), and outputs the next servo interrupt signal (S100). The servo sector number is increased by one (S110), thus corresponding to the third servo sector. After determining that the increased servo sector number is not greater than the maximum servo sector number (S120), SSD information corresponding to the current first offset is loaded (S130), which now corresponds to the fourth servo sector, as discussed above. The loaded SDD information corresponding to the current first offset is then compared with the current servo sector number to determine whether they match (S140). As a result of the comparison, it is determined that the loaded SSD information (e.g., information regarding the fourth servo sector) is different from the current servo sector number (e.g., the third servo sector). Thus, the third servo sector is identified as a defect-free servo sector.

Since a defect-free servo sector has been recognized, the controller 110 loads sector information in the current sector information offset (S170). In the present example, the sector information in the current sector information offset is sector information corresponding to the second servo sector. Accordingly, unlike the conventional method in which sector information corresponding to the recognized servo sector is automatically loaded when the servo sector is recognized, in embodiments of the present invention, the sector information corresponding to a servo sector having a defect is loaded when a subsequent defect-free servo sector is recognized. In other words, a data sector is assigned after a defect-free servo sector has been recognized. Next, the sector information offset is increased (S180) and the remaining processes are performed (S160).

As seen by comparing FIGS. 4 and 7, the arrangement of data sectors may be delayed by as much as an area corresponding to the space between the second servo sector and the third servo sector, for example.

As described above, in the servo sector defect handling method according to embodiments of the present invention, since data sectors are not indiscriminately assigned to a track on a disk, but are adaptively assigned according to servo sector defects, the usage space of the disk is increased, thus more efficiently using data storage areas.

While the present invention has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A method of handling a servo sector defect, the method comprising:
recognizing a first servo sector using a controller;
determining whether the first servo sector has a defect; and
when the first servo sector has a defect, assigning at least a part of a next data sector to be assigned to the first servo sector to a second servo sector having no defect.

2. The method of claim 1, wherein assigning at least a part of the next data sector to the second servo sector comprises:
loading sector information corresponding to the first servo sector, using the controller, after the second servo sector is recognized.

3. The method of claim 2, wherein determining whether the first servo sector has a defect comprises:
loading information stored in a defective servo information storage area, including information about at least one servo sector defect (SSD); and
comparing the loaded SSD information with the first servo sector.

4. The method of claim 3, wherein the SSD information is sequentially stored by a servo sector index in the defective servo information storage area.

5. The method of claim 3, wherein the defective servo information storage area comprises at least one of a maintenance area or a buffer.

6. The method of claim 4, wherein loading the SSD information comprises:
loading information about a servo sector corresponding to a first offset of the defective servo information storage area.

7. The method of claim 6, wherein loading sector information corresponding to the first servo sector after the second servo sector is recognized comprises:
sequentially increasing the first offset until the second servo sector is recognized; and
loading the sector information corresponding to a sector information offset when the second servo sector is recognized.

8. The method of claim 7, further comprising:
increasing the sector information offset after the sector information corresponding to the sector information offset is loaded.

9. The method of claim 2, wherein the sector information corresponding to the first servo sector comprises at least one of information about a position of a first one of data sectors corresponding to the first servo sector, information about a data sector split by a servo sector next to the first servo sector, and information about the number of data sectors corresponding to the first servo sector.
